(19) United States
(12) Patent Application Publication
(10) Pub. No.: US 2007/0261062 A1
(43) Pub. Date: Nov. 8, 2007

(54) Building system event manager

(75) Inventors: Sushil K. Bansal, Kennesaw, GA (US); Abtar Singh, Kennesaw, GA (US)

Correspondence Address: HARNESS, DICKEY & PIERCE, P.L.C., P.O. BOX 828, BLOOMFIELD HILLS, MI, 48303, US

(73) Assignee: Emerson Retail Services, Inc.

(21) Appl. No.: 11/410,841

(22) Filed: Apr. 25, 2006

(51) Int. Cl. G06F 9/46

(52) U.S. Cl. 719/318

(57) ABSTRACT

A method is provided that includes receiving a plurality of event records, each including operating data of at least one of a building system and a building system controller; storing an event record queuing instruction; and ordering an event record queue by applying the event record queuing instruction to each event record. Each event record in the event record queue may be assessed based on the ordering.

### FIELD

The present teachings relate to a building system event management system and method.

### BACKGROUND

Retail outlets, particularly food retailers, require a plurality of building systems during operation. Such building systems often include refrigeration, HVAC, lighting, anti-condensate heating (ACH), and defrost control systems. Each of these building systems includes associated equipment to perform various functions. For example, refrigeration systems include compressors, condensers, evaporators, and the like to cool refrigeration cases to a desired temperature.

Any breakdown or variation in performance of any of the building systems can negatively impact the profits of the retailer. For example, a refrigeration system malfunction may cause food spoilage. Retailers may monitor the building systems for unexpected operation by monitoring certain building system operating parameters, such as a refrigeration system temperature or pressure. A single malfunction, however, may result in the disturbance of many operating parameters.

It is difficult to monitor the building systems for all retail locations. The building systems may operate in an undesired manner or at inefficient levels. The root cause of the disturbance of several operating parameters may not be readily apparent. The appropriate service persons may not be quickly dispatched to the retail location to correctly address the problem. Further, it may not be desirable to monitor all events all the time.

### SUMMARY

A method includes receiving event records that include operating data of a building system or building system controller. The method also includes storing an event record queuing instruction and ordering an event record queue by applying the event record queuing instruction to each event record. Each event record in the event record queue may be assessed based on the ordering.

A system is also provided. The system includes a queue for event records, each including operating data of at a building system or building system controller. The system also includes an event record management module that receives event records from a connected event record source and an event record queuing instruction from a connected event record queuing instruction source. Queued event records are ordered in the queue by the event record management module through application of the received event record queuing instruction to the received event records.

Further areas of applicability of the present teachings will become apparent from the detailed description provided hereinafter. It should be understood that the detailed description and specific examples are intended for purposes of illustration only and are not intended to limit the scope of the claims.

### BRIEF DESCRIPTION OF THE DRAWINGS

The present teachings will become more fully understood from the detailed description and the accompanying drawings, wherein:

FIG. 1 is a schematic illustration of an event record management system;

FIG. 2 is an event record data structure;

FIG. 3 is a schematic illustration of a refrigeration system with a monitoring system;

FIG. 4 is a schematic illustration of an HVAC system with a monitoring system;

FIG. 5 is a schematic illustration of a lighting system with a monitoring system;

FIG. 6 is a flowchart illustrating an event record management algorithm;

FIG. 7 is a flowchart illustrating an event record management algorithm;

FIG. 8 is a flowchart illustrating an event record management algorithm;

FIG. 9 is a schematic illustration of another event record management system;

FIG. 10 is a schematic illustration of another event record management system; and

FIG. 11 is a schematic illustration of another event record management system.

### DETAILED DESCRIPTION

The following description is merely exemplary in nature and is in no way intended to limit the teachings, its application, or uses. As used herein, the terms module, control module, and controller refer to an application specific integrated circuit (ASIC), an electronic circuit, a processor (shared, dedicated, or group) and memory that execute one or more software or firmware programs, a combinational logic circuit, and/or other suitable components that provide the described functionality. Further, as used herein, computer-readable medium refers to any medium capable of storing data for a computer. Computer-readable medium may include, but is not limited to, CD-ROM, floppy disk, magnetic tape, other magnetic or optical medium capable of storing data, memory, RAM, ROM, PROM, EPROM, EEPROM, flash memory, punch cards, dip switches, or any other medium capable of storing data for a computer.

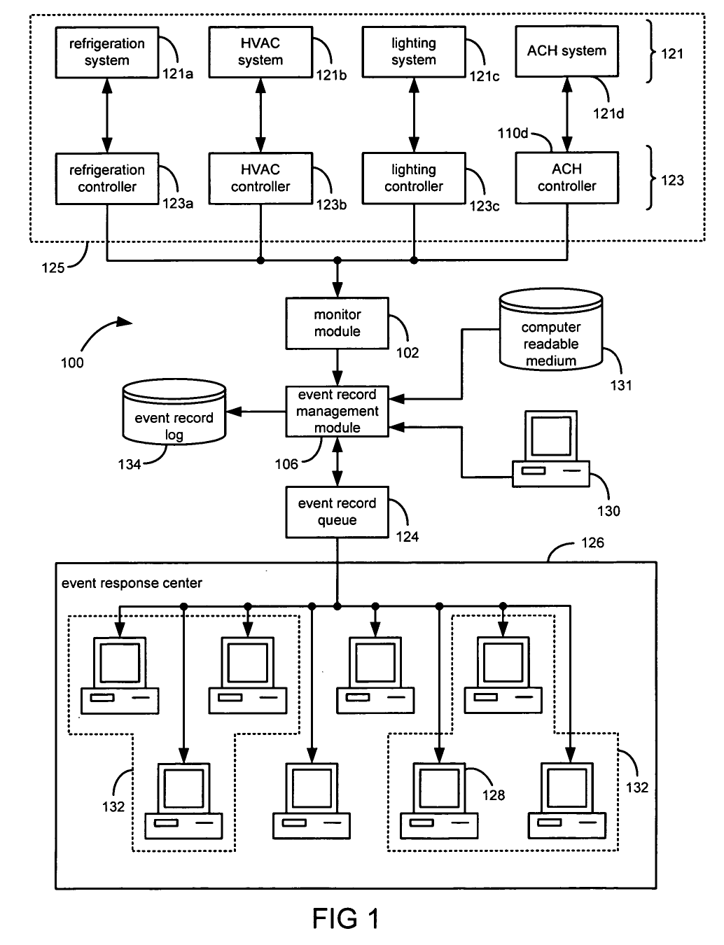

With reference to FIG. 1, an event record management system 100 may include a monitor module 102 to monitor one or more building system controllers 123 for one or more building systems 121 at a site facility 125. The site facility 125 may be any commercial or residential building or buildings configured with one or more building systems 121. The monitor module 102 may monitor operating data of the controllers 123 and may generate event records based on various predetermined operating conditions of the controllers 123 or building systems 121. For example, an event record may be generated when a building system 121 operates unexpectedly or requires maintenance. Additionally, an event record may be generated after a predetermined time period.

Event records generated by the monitor module 102 may be received by an event record management module 106. The event record management module 106 may order event records in an event record queue 124 for handling by an event response center 126. Generally, the event record management module 106 inserts event records in the event record queue 124. The event record management module 106 may execute event record management algorithms, including an event record disregard algorithm, an event record grouping algorithm, and an event record routing algorithm, discussed in more detail below. The event record management algorithms may be stored in a computer readable medium 131 accessible to the event record management module 106.

The building systems 121 may include a refrigeration system 121a, an HVAC system 121b, a lighting system 121c, and/or an anti-condensate heating (ACH) system 121d. As can be appreciated, other building systems, such as a defrost control system, an electrical system, or the like, may be included. Further, other building system combinations may be used at a particular site facility 125. The building systems 121 may be controlled by controllers 123 including a refrigeration controller 123a, an HVAC controller 123b, a lighting controller 123c, and/or an ACH controller 123d. While separate controllers 123 are shown in FIG. 1, a single controller 123 may control more than one building system 121. Thus, any number of building systems 121 may be controlled by any number of controllers 123.

The monitor module 102 may communicate with the controllers 123 to monitor operating data of each of the controllers 123 and each of the building systems 121. When a building system 121 operates unexpectedly, is in need of maintenance, or otherwise requires attention, the monitor module 102 may generate an event record with operating data corresponding to the operating condition that caused the event record to be generated. For example, the event record may include data indicating a high discharge temperature of a condenser of the refrigeration system 121a, a loss of power of a building system 121 or building system component, or an approaching scheduled maintenance deadline of a building system or building system component. Additionally, an event record may be generated based on a predetermined time period. For example, an event record may be generated periodically to indicate that a building system 121 is operating correctly.

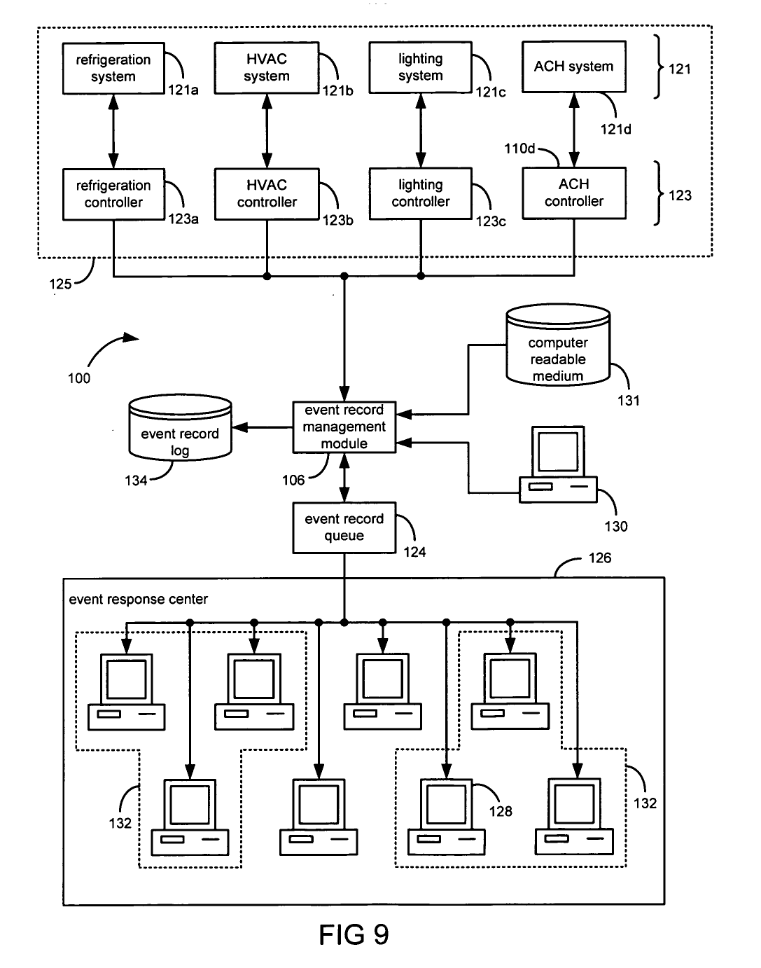

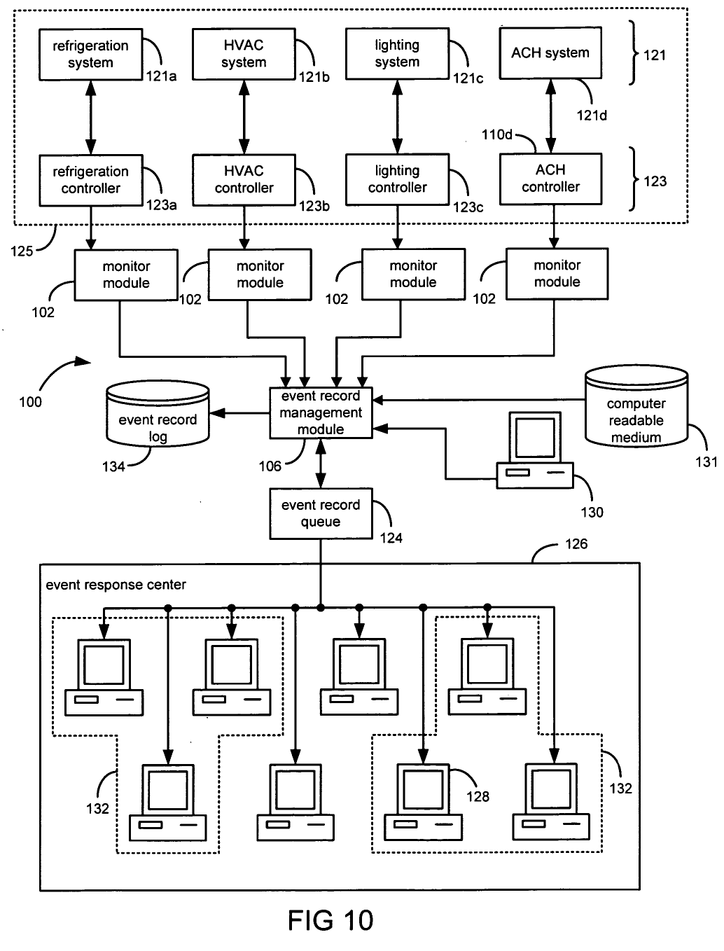

Alternatively, a controller 123 may generate event records, instead of the monitor module 102. A controller 123 may generate an event record when a building system 121 operates unexpectedly, is in need of maintenance, or otherwise requires attention. In such case, a separate monitor module 102 may not be needed. Referring now to FIG. 9, an event record management system 100 without a monitor module 102 is shown. Further, instead of utilizing one monitor module 102 to monitor all controllers 123, each controller 123 may be configured with its own monitor module 102 for monitoring operating data of the associated controller 123 and for generating event records. Referring now to FIG. 10, an event record management system 100 with a separate monitor module 102 for each controller 123 is shown. In each case, generated event records may be received by an event record management module 106.

Referring again to FIG. 1, the event record management module 106 may be configured with event record queuing instructions received from a configuration terminal 130. The event record management module 106 may execute event record management algorithms stored in a computer-readable medium 131 accessible to the event record management module 106. The computer readable medium 131 may be local or remote to the event record management module 106.

The event record management module 106 may store the event records in an event record log 134 accessible to the event record management module 106. The event record log 134 may be a computer-readable medium for storing event records. The computer-readable medium 131 and the event record log 134 may reside on the same computer-readable medium device, such as a hard disk accessible by the event record management module 106 for reading and writing data. The event record management module 106 may be implemented in software.

The event record management module 106 may insert event records in the event record queue 124. The event record queue 124 may be a first-in-first-out queue connected to an event response center 126. However, the event record management module 106 may vary from the first-in-first-out rule based on event record queuing instructions received from the configuration terminal 130.

The event response center 126 may include event response terminals 128. An operator at an event response terminal 128 may facilitate the appropriate response to the generated event record. For example, an operator at an event response terminal 128 may dispatch a service technician to the site facility 125 to perform maintenance and/or diagnostics in response to, and as dictated by, the generated event record.

The configuration terminal 130 may provide the event record management module 106 with event record queuing instructions based on input received from a user operating the configuration terminal 130. When event record queuing instructions have not been received, the event record management module 106 may simply insert each event record in the order received into the event record queue 124 for handling. In such case, all event records may be inserted individually into the event record queue 124 for handling by the next available response terminal 128.

The configuration terminal 130 may provide the event record management module 106 with event record queuing instructions including event record disregard, grouping, and routing instructions. Based on the event record queuing instructions, the event record management module 106 may disregard certain event records by refraining from inserting the particular event record into the event record queue 124.

The event record management module 106 may also insert an event record in the event record queue by grouping the event record with other event records already inserted the event record queue 124 based on the received event record queuing instructions. Further, the event record management module 106 may insert an event record with routing data sufficient to route the event record to a specific event response terminals 128 or terminal groups 132 based on received event record queuing instructions.

For example, the event record management module 106 may be configured to disregard event records corresponding to a certain site facility 125 or controller 123 during a specified period of time. Additionally, the event record management module 106 may be configured to group certain event records together in the event record queue. In this way, the grouped event records may be placed in the event record queue 124 together, and handled concurrently by an operator at an event response terminal 128. Further, the event record management module 106 may be configured, based on the event record queuing instructions, to route certain event records to certain event response terminals 128 or terminal groups 132. In this way, certain event response terminals 128 may be specially configured to respond to certain types of event records, or operated by operators specially trained to respond to certain types of event records. For example, an event response terminal operator may be trained with regard to a certain type of controller.

The monitor module 102, event record management module 106, event record queue 124, and event response center 126 may be local or remote to the site facility 125. The refrigeration controller 123a, HVAC controller 123b, lighting controller 123c, ACH controller 123d, monitor module 102, event record management module 106, event record queue 124, and event response center 126 may communicate via a network, using LAN connections, internet connections, or other suitable network/communication connections. The connections may be wired or wireless connections. Any suitable communication connection, allowing data transfer between the various components may be used.

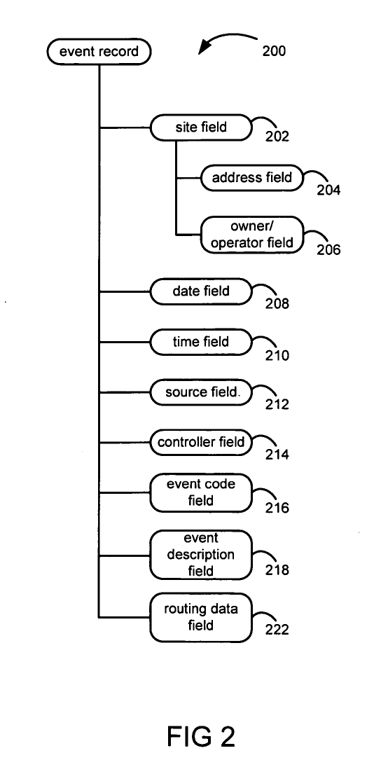

Referring now to FIG. 2, an event record data structure 200 may include a site field 202, an address field 204, and an owner/operator field 206 corresponding to the site facility 125, the address of the site facility, and the owner/operator of the site facility 125 corresponding to the event record. The event record data structure 200 may also include a date field 208 and a time field 210 corresponding to the date and time when the event record was generated.

The event record data structure 200 may include a source field 212 which corresponds to the specific source of the operating conditions precipitating the generation of the event record, such as a specific piece of system equipment. The event record data structure 200 may include a controller field 214 corresponding to a specific controller 123 that generated the operating conditions precipitating the generation of the event record.

The event record data structure 200 may include an event description field 218 corresponding to a text description of the event condition, such as “high discharge pressure” or “parking lot lights—no power”. The event record data structure 200 may include an event code field 216 corresponding to a predetermined event code indicating the operating conditions precipitating the generation of the event record. For example, a specific event code may correspond to a “low suction pressure” condition.

The event record data structure 200 may include a routing data field 222 for storing specific routing information, as described in more detail below. While specific event record data fields are shown in FIG. 2, any other data associated with an event record or with the operation of a building system may be included in the event record. Further, any other data that may assist an operator at an event response terminal 128 in responding to an event record may be included in the event record data structure 200.

Specific event record instances, or event record objects, may be generated by the monitor module 102 or by the controllers 123 when a building system 121 or controller 123 operates unexpectedly or requires maintenance or attention. In such case, an event record may be generated with the appropriate data corresponding to operating conditions of the building system 121. Additionally, an event record may be generated as a matter of course upon the passage of a predetermined time period or upon the happening of a predetermined triggering operation. Alternatively, the controllers 123 may monitor system operation and generate event records as necessary. In such case, the specific building system controllers 123 may send the generated event record to the monitor module 102, or directly to the event record management module 106. In an event record management system 100 where the controllers 123 send generated event records directly to the event record management module 106, a separate monitor module 102 may be excluded.

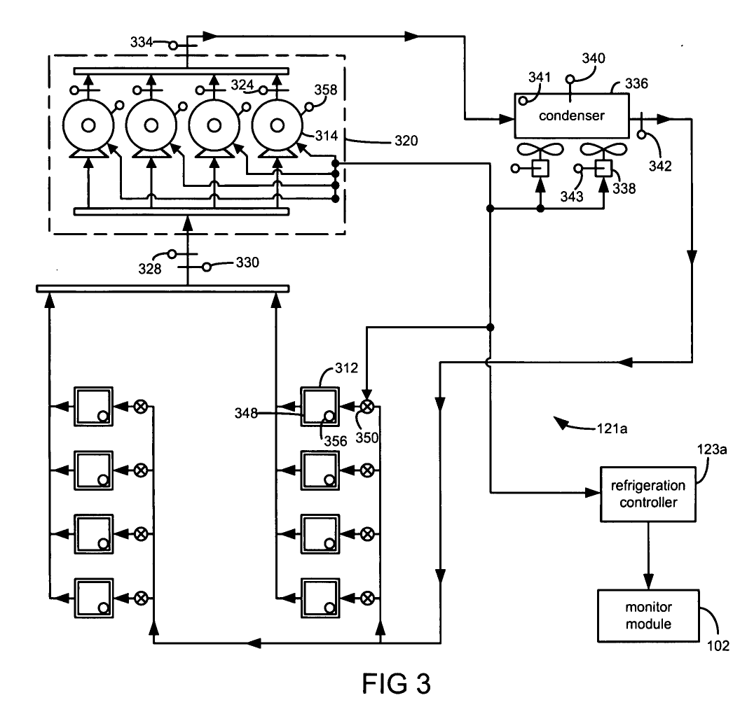

Referring now to FIG. 3, a refrigeration system 121a may include refrigeration cases 312, as well as a plurality of compressors 314 piped together and positioned within a compressor rack 320. A discharge output of each compressor 314 may include respective compressor temperature sensors 324. A suction inlet may include both a suction pressure sensor 328 and a suction temperature sensor 330. Further, a discharge outlet may include a compressor discharge pressure sensor 334. An electrical current sensor 358 may be attached to each compressor 314. The various sensors may be connected to the refrigeration controller 123a which controls and monitors compressor operation.

The compressor rack 320 may compress refrigerant vapor that is delivered to a condenser 336. Condenser fans 338 may enable improved heat transfer from the condenser 336. The condenser 336 may include an associated ambient temperature sensor 340, a condenser temperature sensor 341, and/or a condenser discharge pressure sensor 342. An electrical current sensor 343 may be attached to each condenser fan 338. The various sensors are connected to the refrigeration controller 123a which controls condenser fan operation.

Each refrigeration case 312 may include its own evaporator 348, its own expansion valve 350 for controlling the superheat of the refrigerant, and its own temperature sensor 356. The refrigerant passes through the expansion valve 350 where a pressure drop causes the high pressure liquid refrigerant to achieve a lower pressure combination of liquid and vapor. The temperature sensor 356 may be connected to the refrigeration controller 123a.

The refrigeration controller 123a may receive operating data for the refrigeration system 121a from the respective temperature, pressure, and current sensors 324, 328, 330, 334, 340, 341, 342, 343, 356, 358. The monitor module 102 may receive refrigeration system operating data from the refrigeration controller 123a. By monitoring the refrigeration system operating data, the monitor module 102 may determine when the refrigeration system 121a is operating unexpectedly. For example, the monitor module 102 may determine that a discharge pressure or discharge temperature of the compressor 314 is unexpectedly high for the given ambient temperature. In such case, the monitor module 102 may generate an event record based on the high compressor discharge temperature. Additionally, the monitor module 102 may determine that a condenser fan 338 is not drawing any electrical current, despite being activated. In such case, the monitor module 102 may generate an event record indicating a condenser fan malfunction. Event records may also be generated by the refrigeration controller 123a.

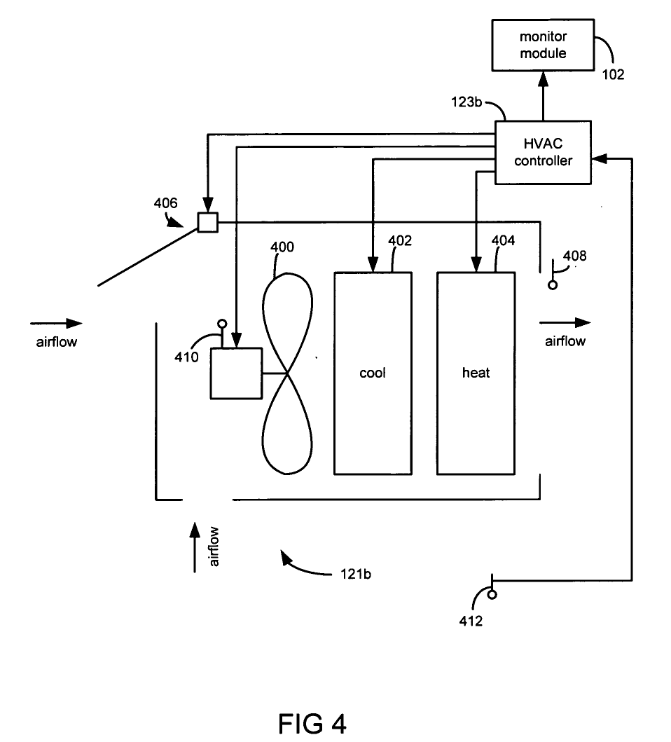

Referring now to FIG. 4, the HVAC system 121b may include a fan 400 as well as a cooling apparatus 402, a heating apparatus 404, and a damper 406, if appropriate. The HVAC controller 123b may control the fan 400, cooling apparatus 402, heating apparatus 404, and damper 406 to heat or cool as desired. A temperature sensor 408 may indicate a temperature of air exiting the cooling apparatus 402 or heating apparatus 404. An electrical current sensor 410 may be attached to the fan 400. A room temperature sensor 412 may also be placed proximate the heated/cooled area. The HVAC controller 123b may receive HVAC system operating data from the temperature and electrical current sensors 408, 410, 412. As can be appreciated, additional room temperature sensors may be used depending on the size and configuration of the interior of the building to be heated or cooled.

The HVAC system operating data may be available to the monitor module 102 which monitors operation of the HVAC system 121b. The monitor module 102 determines when the HVAC system 121b is operating unexpectedly based on the operating data. In such case, the monitor module 102 may generate an event record based on the unexpected operation. Additionally, event records may be generated by the HVAC controller 123b based on the HVAC system operating data.

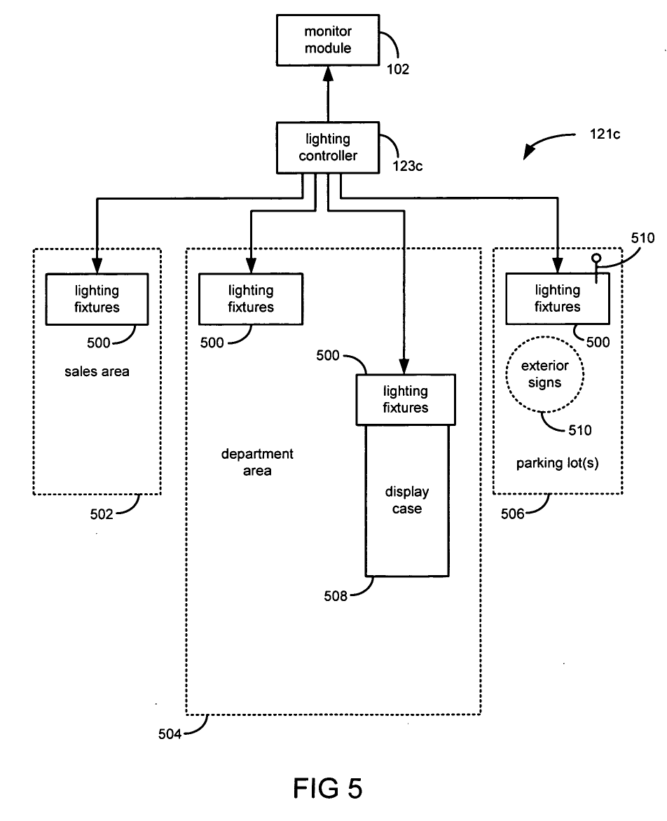

Referring now to FIG. 5, a lighting system 121c may include one or more lighting fixtures 500 which may communicate with the lighting controller 123c. The lighting controller 123c may receive operating data of the lighting system 121c. The lighting fixtures 500 are shown in various areas of a building and its exterior, with some areas including multiple types of fixtures while lighting fixtures for multiple areas may also be similarly controlled. For example, a sales area 502, a department area 504, and a parking lot 506 may each include lighting fixtures 500. The department area 504 may include lighting fixtures 500 for a display case 508 therein. The parking lot 506 may include lighting fixtures 500 as well as exterior sign lighting 510. The parking lot light fixtures 500 may be equipped with a light sensor 510 and configured to turn on at dusk. The various lighting fixtures 500 may be in communication with the lighting controller 123c via direct or wireless connections. Any suitable network connection, allowing communication between the lighting controller 123c and the lighting fixtures 500 may be used.

The monitor module 102 may detect when the lighting system 121c is operating unexpectedly by communicating with the lighting controller 123c. For example, the lighting controller 123c may detect that a lighting fixture 500 does not turn on or turn off as expected. The lighting fixture malfunction may be caused by a burnt out light bulb or a defective light sensor 510. In such case, the monitor module 102 may generate an event record based on the unexpected operation. Additionally, the lighting controller 123c may generate an event record based on the operating data of the lighting system 121c.

Referring again to FIG. 1, an ACH system 121d may include one or more anti-condensate heaters, and may be in communication with an ACH controller 123d. The ACH controller 123d controls ACH system operation. The monitor module 102 may monitor ACH operating data and detect when the ACH system 121d is operating unexpectedly by communicating with the ACH controller 123d. The monitor module 102 may generate an event record based on the unexpected operation. Additionally, the ACH controller 123d may generate an event record based on ACH operating data.

While a refrigeration system 121a, an HVAC system 121b, a lighting system 121c, and an ACH system 121d are show in FIG. 1, any number of building systems 121 may be used. Further, more than one instance of any given building system 121 may be included. For example, multiple refrigeration systems 121a with multiple refrigeration controllers 123a may be connected to the monitor module 102.

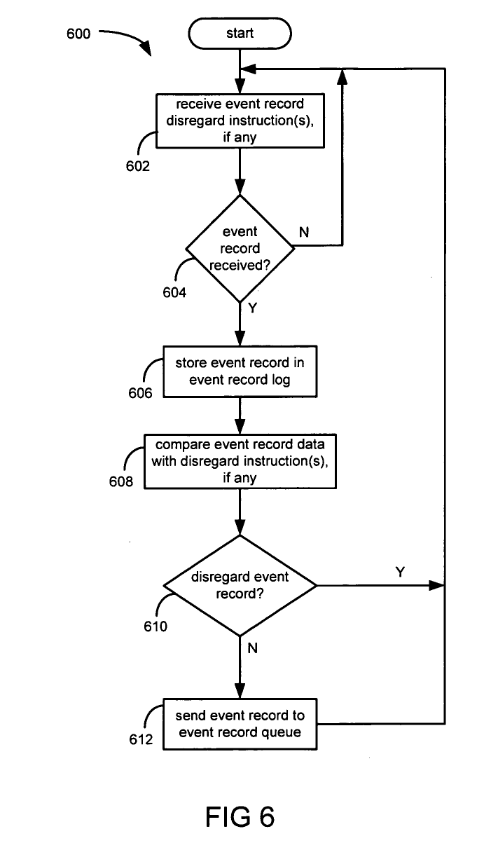

With reference to FIG. 6, an event record disregard algorithm 600 may be executed by the event record management module 106. The event record disregard algorithm 600 is one of the event record management algorithms that may be executed by the event record management module 106. In step 602, the event record management module 106 may receive an event record disregard instruction, or instructions, if any have been inputted, from the configuration terminal 130.

The configuration terminal 130 may be a dedicated terminal for configuring the event record management module 106 with event record queuing instructions, such as an event record disregard instruction. Alternatively, the configuration terminal 130 may be one of the terminals in the event response center 126. For example, the event response terminals 128 may include event record management module configuration functionality, and may function as a configuration terminal 130.

Referring again to FIG. 2, the event record disregard instruction may include any of the event record data fields included in the event record. For example, event records corresponding to a specific site facility 125 or from a specific source (i.e., controller or component) may be disregarded. Further, date and time ranges may be included as well. A start date, start time, end date, and end time may be specified. For example, the event record disregard instruction may specify that event records generated between the start date at the start time and the end date at the end time are to be disregarded.

Additionally, the event record disregard instruction may specify that events generated each day during a specified time period may be disregarded. For example, the specified time period may be certain hours of the day, or days of the month. The specified time period may be a recurring time period, such that the time period recurs on an hourly, daily, weekly, monthly or yearly basis. For example, the time period may be the same day of the week, e.g., Sunday, or the same hours of the day, e.g., eight p.m. to six a.m. each week and each day.

For example, a user may submit an event disregard instruction to specify that event records associated with an HVAC system 121b and generated between the hours of eight p.m. and six a.m. each day are to be disregarded. Further, event records generated during certain hours of certain days of the week may be disregarded. For example, an event record disregard instruction user may specify that event records corresponding to an HVAC system 121b are to be disregarded between the hours of eight p.m. and six a.m. each Friday, Saturday, and Sunday. Further, a date range may be included in the event record disregard instruction along with the days-of-the-week specifications. For example, a user may specify that event records corresponding to an HVAC system 121b and generated between the hours of eight p.m. and six a.m. each Friday, Saturday, and Sunday between July first and July thirty-first are to be disregarded.

Previously specified event record disregard instructions may be modified by the configuration terminal 130 as well. Any such modified event record disregard instructions are received by the event record management module 106 in step 602 as well.

In step 604, the event record management module 106 may determine whether an event record has been received. As discussed above, event records may be received from the monitor module 102 or from the controllers 123. In step 604, when an event record is not received, the event record management module 106 may loop back to step 602.

In step 604, when an event record is received, the event record management module 106 may proceed to step 606 to store the event record in the event record log 134. In this way, event record data for each received event record may be stored in the event record log 134. All of the event record data, or a subset of the event record data, may be stored. For example, the stored data may include event record date, time, and source only.

In step 608, the event record management module 106 may compare the event record data of the current event record with the previously received event record disregard instruction or instructions, if any. In step 610, the event record management module 106 may determine whether the current event record should be disregarded, based on the comparison with the event record disregard instructions in step 608. As discussed above, the event record management module 106 may compare certain specified fields of the event record with the received event record disregard instruction.

In step 610, when the current event record is to be disregarded, based on the comparison with the event record disregard instruction, the event record management module 106 may simply loop back to step 602 to wait for additional event records and event record disregard instructions. In this way, when the current event record should be disregarded, based on the received event record disregard instruction, the event record may only be recorded in the event record log 134. Further processing of the disregarded event record may not be performed. The disregarded event record may not be sent to the event record queue 124 for handling by the event response center 126. Alternatively, the event record disregard instruction may specify that certain event records are not to be stored in the event record log 134 either. Such event records may be completely disregarded, as they are neither stored in the event record log 134 nor passed on to the event record queue 124.

In step 610, when the current event record is not to be disregarded, based on the event record disregard instruction or instructions, the event record management module 106 may proceed to step 612. In step 612, the event record management module 106 may send the current event record to the event record queue 124. The event record may then “wait” in the event record queue 124 until an event response terminal 128 becomes available to handle the event record. After sending the event record to the event record queue in step 612, the event record management module 106 may loop back to step 602 to wait for additional event records or event record disregard instructions.

In this way, by executing the event record disregard algorithm 600, the event record management module 106 may selectively send event records to the event record queue 124 for response, based on the event record disregard instruction or instructions received from the configuration terminal 130.

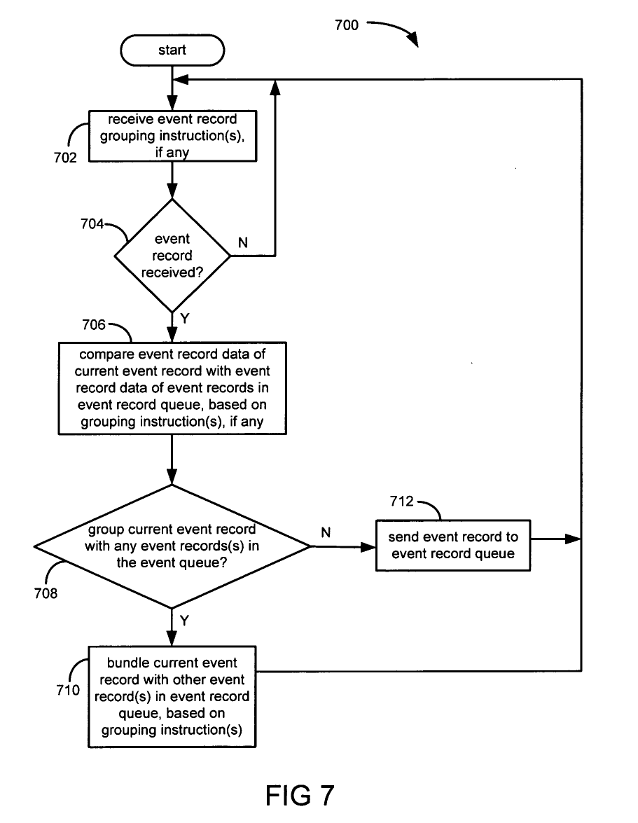

With reference to FIG. 7, an event record grouping algorithm 700 may be executed by the event record management module 106. The event record grouping algorithm 700 is one of the event record management algorithms that may be executed by the event record management module 106. In step 702, the event record management module 106 may receive an event record grouping instruction, or instructions, if any have been inputted, from the configuration terminal 130.

The event record grouping instruction or instructions may include any of the event record data fields, as shown in FIG. 2. For example, all of the event records from a specified site or from a specified source (i.e., controller or component) may be grouped together. Further, an event record grouping instruction may indicate that all of the event records from a specified site facility 125 are to be grouped together.

The event record management module 106 may proceed to step 704 and determine whether an event record has been received. In step 704, when an event record is not received, the event record management module 106 may loop back to step 702.

In step 704, when an event record is received, the event record management module 106 may proceed to step 706 to compare the event record data of the current event record with event record data of event records in the event record queue, based on any received event record grouping instructions. In step 708, the event record management module 106 may determine whether the current event record can be grouped with any event record(s) in the event record queue 124.

In step 708, when the current event record can be grouped with one or more event records currently in the event record queue 124, the event record management module 106 may proceed to step 710 and bundle the current event record with the other event record or records in the event record queue, based on the event record grouping instruction or instructions. The event records may be bundled by a linked-list, an array, or other suitable data structure for grouping multiple records together. After bundling the current event record with the other event record or records in the event record queue 124, the event record management module 106 may loop back to step 702.

In step 708, when the current event record cannot be grouped with any events in the event record queue 124, the event record management module 106 may send the current event record to the end of the event record queue 124 in step 712 and loop back to step 702.

In this way, multiple event records with a shared root cause may be grouped together for handling in the event record queue 124. For example, the event record management module 106 may be configured to group event records from the same site facility 125. For example, when a power outage occurs, an event may be generated for each building system 121, or for each component of each building system of a single site. By grouping all such event records together, an event response center operator may be able to quickly recognize that a power outage has occurred at the site, and that all of generated event records relate to the power outage. Without grouping, the separate event records may be dispersed to different event response terminals 128 and the root cause of the event records, the power outage for example, may not be quickly recognized.

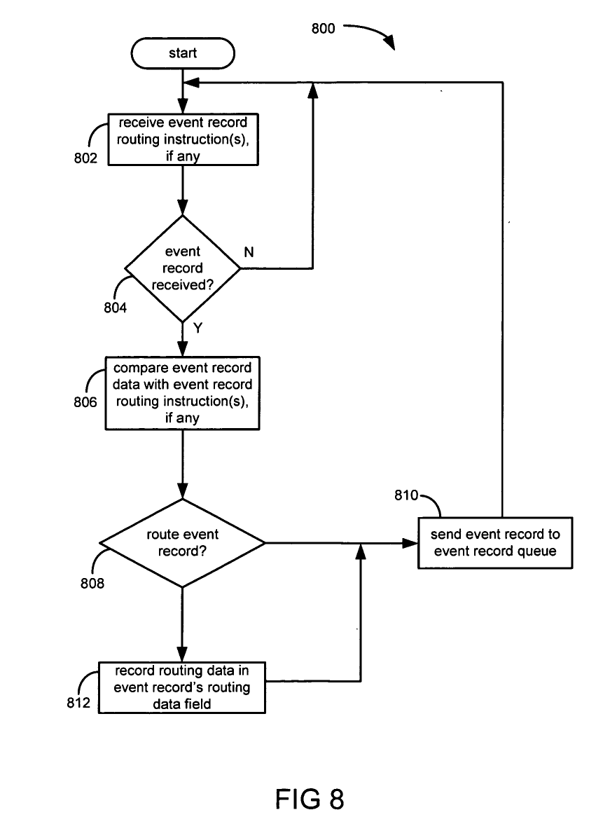

With reference to FIG. 8, an event record routing algorithm 800 may be executed by the event record management module 106. The event record routing algorithm 800 is one of the event record management algorithms that may be executed by the event record management module 106. In step 802, the event record management module 106 may receive an event record routing instruction, or instructions, if any have been inputted, from the configuration terminal 130.

As with the event record disregard instructions and the event record grouping instructions, the event record routing instructions may include any of the event record data fields. Additionally, the event record grouping instruction may include a specified event response terminal 128 or event response terminal group 132.

Certain event response center operators may be specially trained to handle events from certain building systems 121 or certain types of controllers 123. For example, an event response center operator may be specially trained to handle refrigeration system 121a or refrigeration controller 123a event records only. Additionally, an event response center operator may be specially trained to handle event records from controllers 123 manufactured by certain manufacturers.

The event response center 126 may be segregated into different event response terminal groups 132 corresponding to the training of the respective event response center operators. Additionally, certain event response terminals 128 may be specially configured to handle event records from certain building systems 121 or controllers 123. The event record management module 106 may route event records from the event record queue 124 to appropriate event response terminals 128 or event response terminal groups according to event record routing instructions.

The event record management module 106 may proceed to step 804 to determine whether an event record has been received. In step 804, when an event record is not received, the event record management module 106 may loop back to step 802.

In step 804, when an event record is received, the event record management module 106 may proceed to step 806 to compare the event record with the event record routing instruction or instructions, if any. In step 808, the event record management module 106 may determine whether the current event record should be routed to a particular event response terminal 128 or event response terminal group 132 based on the comparison of step 806.

In step 808, when the current event record should not be routed to a particular event response terminal 128 or event response terminal group 132, the event record management module 106 may send the event record to the event record queue 124 in step 810.

In step 808, when the current event record should be routed to a particular event response terminal 128 or event response terminal group 132, the event record management module may proceed to step 812 and record the appropriate routing data in the routing field of the event record.

With reference to FIG. 2, each event record data structure may contain a routing data field 222. The event record management module 106 may record the appropriate routing data in the current event record routing data field 222. The routing data may indicate the appropriate event response terminal 128 or event response terminal group 132 that must respond to the event record. In step 810 the event record management module 106 may send the event record to the event record queue 124.

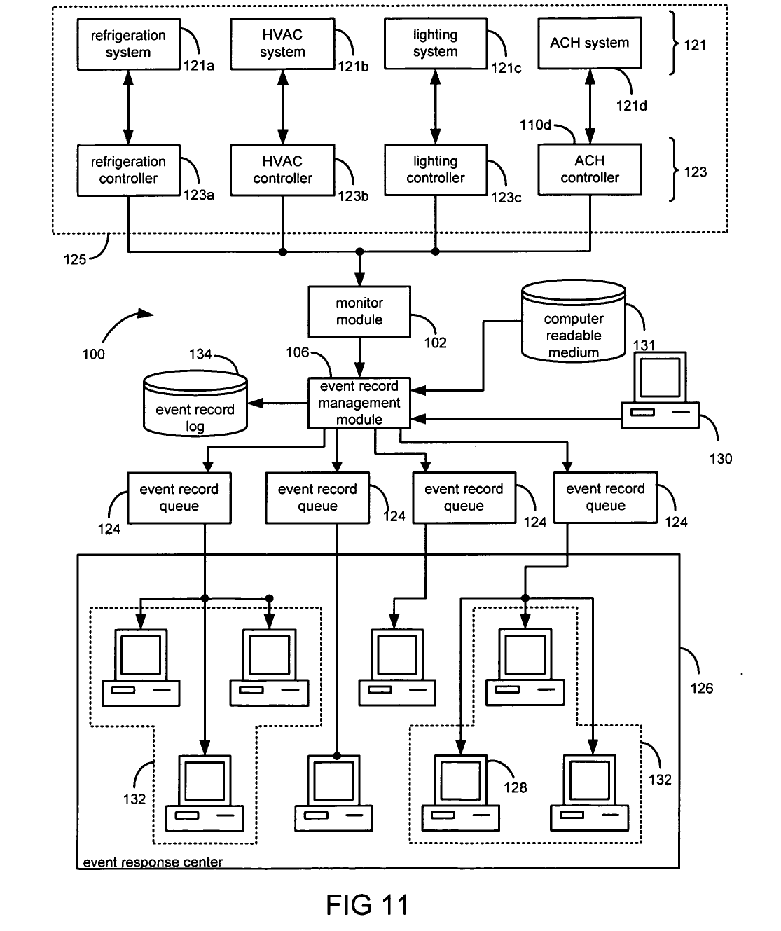

Alternatively, separate event record queues 124 may be maintained to facilitate the routing of event records. Referring now to FIG. 11, a separate event record queue 124 may be maintained for each different event response terminal 128 or event response terminal group 132 as designated by any event record routing instructions. In such case, the event record data structure 200, as shown in FIG. 2, may not require a routing data field 222, as the event record management module may simply route event records by placing them in the appropriate event record queue 124.

In any case, the event response terminals 128 may retrieve event records from the event record queue 124. If the particular event response terminal 128 may only receive certain event records with designated routing data, the particular event response terminal 128 may check the routing data of the event record prior to retrieving the event record form the event record queue. When the routing data is compatible, the event response terminal 128 may proceed with retrieving the event record. If the routing data is not compatible, the event response terminal 128 may look past the event record to the next event record in the event record queue. The passed over event record may then remain in the event record queue for handling by the appropriate event response terminal 128 or event response terminal group 132. Alternatively, if different event record queues 124 are used for differently routed event records, then the event response terminal 128 may simply retrieve the next event record from the appropriate event record queue 124.

In this way, event records may be routed to the appropriate event response terminal 128 or event response terminal group 132 as indicated by the event record routing data, and as dictated by the event record routing instruction or instructions, if any.

What is claimed is:

1. A method comprising:
receiving a plurality of event records, each including operating data of at least one of a building system and a building system controller;
storing an event record queuing instruction;
ordering an event record queue by applying said event record queuing instruction to each event record of said plurality;
whereby each event record in said event record queue may be assessed based on said ordering.

2. The method of claim 1 further comprising handling each event record in said event record queue using at least one response terminal.

3. The method of claim 1 wherein said storing said event record queuing instruction includes storing an event record disregard instruction.

4. The method of claim 3 wherein said ordering said event record queue by applying said event record queuing instruction to each event record of said plurality includes:
comparing said operating data for each event record of said plurality with said event record disregard instruction;
selectively inserting each event record of said plurality in said event record queue based on said comparing.

5. The method of claim 4 wherein said storing said event record disregard instruction includes storing a time period designation and wherein said selectively inserting each event record includes inserting each event record not generated during said time period designation.

6. The method of claim 5 wherein said storing said time period designation includes storing a recurring time period.

7. The method of claim 6 wherein said storing said recurring time period includes storing at least one of an hourly, daily, weekly, monthly or yearly time period.

8. The method of claim 4 wherein said storing said event record disregard instruction includes storing a site facility designation and wherein said selectively inserting each event record includes inserting each event record with operating data that does not correspond with said site facility designation.

9. The method of claim 4 wherein said storing said event record disregard instruction includes storing a building system designation and wherein said selectively inserting each event record includes inserting each event record with operating data that does not correspond with said building system designation.

10. The method of claim 4 wherein said storing said event record disregard instruction includes storing a building system controller designation and wherein said selectively inserting each event record includes inserting each event record with operating data that does not correspond with said building system controller designation.

11. The method of claim 1 wherein said storing said event record queuing instruction includes storing an event record grouping instruction.

12. The method of claim 11 wherein said ordering said event record queue by applying said event record queuing instruction to each event record of said plurality includes:
comparing said operating data for each event record of said plurality with said event record disregard instruction;
selectively grouping event records of said plurality in said event record queue based on said comparing.

13. The method of claim 12 wherein said storing said event record grouping instruction includes storing a site facility designation and wherein said selectively grouping event records of said plurality includes grouping event records with operating data corresponding to said site facility designation.

14. The method of claim 12 wherein said storing said event record grouping instruction includes storing a building system designation and wherein said selectively grouping event records of said plurality includes grouping event records with operating data corresponding to said building system designation.

15. The method of claim 12 wherein said storing said event record grouping instruction includes storing a building system controller designation and wherein said selectively grouping event records of said plurality includes grouping event records with operating data corresponding to said building system controller designation.

16. The method of claim 1 wherein said storing said event record queuing instruction includes storing an event record routing instruction that includes an event record destination.

17. The method of claim 16 wherein said storing an event record routing instruction that includes said event record destination includes storing an event response terminal destination.

18. The method of claim 16 wherein said storing an event record routing instruction that includes said event record destination includes storing an event response terminal group destination.

19. The method of claim 16 wherein said ordering said event record queue by applying said event record queuing instruction to each event record of said plurality includes:
comparing said operating data for each event record of said plurality with said event record routing instruction;
selectively routing each event record of said plurality to said event record destination based on said comparing.

20. The method of claim 19 wherein said selectively routing each event record includes selectively inserting routing data in each event record.

21. The method of claim 19 further comprising creating an additional queue for said event record destination, wherein said selectively routing each event record includes selectively inserting each event record in said additional queue based on said comparing.

22. The method of claim 19 wherein said storing said event record routing instruction includes storing a site facility designation and wherein said selectively routing each event record includes routing each event record with operating data corresponding with said site facility designation to said event record destination.

23. The method of claim 19 wherein said storing said event record routing instruction includes storing a building system designation and wherein said selectively routing each event record includes routing each event record with operating data corresponding with said building system designation to said event record destination.

24. The method of claim 19 wherein said storing said event record routing instruction includes storing a building system controller designation and wherein said selectively routing each event record includes routing each event record with operating data corresponding with said building system controller designation to said event record destination.

25. The method of claim 1 further comprising recording said event record in an event record log.

26. A computer-readable medium having computer-executable instructions for performing the method of claim 1.

27. A computer-readable medium having computer-executable instructions for performing the method of claim 4.

28. A computer-readable medium having computer-executable instructions for performing the method of claim 12.

29. A computer-readable medium having computer-executable instructions for performing the method of claim 17.

30. A system comprising:
a queue for event records, each including operating data of at least one of a building system and a building system controller,
an event record management module that receives event records from a connected event record source and an event record queuing instruction from a connected event record queuing instruction source;
wherein queued event records are ordered in said queue by said event record management module through application of said received event record queuing instruction to said received event records.

31. The system of claim 30 wherein said received event record queuing instruction includes an event record disregard instruction and wherein said event record management module compares said event record disregard instruction with operating data of each received event record and selectively inserts each received event record in said queue based on said comparison.

32. The system of claim 31 wherein said event record disregard instruction includes a time period designation and wherein each received event record not generated during said time period designation is inserted in said queue.

33. The system of claim 32 wherein said time period designation recurs at least one of hourly, daily, weekly, monthly and yearly.

34. The system of claim 31 wherein said event record disregard instruction includes a site facility designation and wherein each received event record with operating data not corresponding with said site facility designation is inserted in said queue.

35. The system of claim 31 wherein said event record disregard instruction includes a building system designation and wherein each received event record with operating data not corresponding with said building system designation is inserted in said queue.

36. The system of claim 31 wherein said event record disregard instruction includes a building system controller designation and wherein each received event record with operating data not corresponding with said building system controller designation is inserted in said queue.

37. The system of claim 30 wherein said received event record queuing instruction includes an event record grouping instruction and wherein said event record management module compares said event record grouping instruction with operating data of each received event record and selectively groups received event records in said queue based on said comparison.

38. The system of claim 37 wherein said at least one event record grouping instruction includes a site facility designation and wherein received event records with operating data corresponding with said site facility designation are grouped together in said queue.

39. The system of claim 37 wherein said at least one event record grouping instruction includes a building system designation and wherein received event records with operating data corresponding with said building system designation are grouped together in said queue.

40. The system of claim 37 wherein said at least one event record grouping instruction includes a building system controller designation and wherein received event records with operating data corresponding with said building system controller designation are grouped together in said queue.

41. The system of claim 30 wherein said received event record queuing instruction includes an event record routing instruction with an event record destination and wherein said event record management module compares said event record routing instruction with operating data of each received event record and selectively routes received event records to said event record destination based on said comparison.

42. The system of claim 41 wherein said at least one event record routing instruction includes a site facility designation and wherein received event records with operating data corresponding with said site facility designation are routed to said event record destination.

43. The system of claim 41 wherein said at least one event record routing instruction includes a building system designation and wherein received event records with operating data corresponding with said building system designation are routed to said event record destination.

44. The system of claim 41 wherein said at least one event record routing instruction includes a building system controller designation and wherein received event records with operating data corresponding with said building system controller designation are routed to said event record destination.

45. The system of claim 41 wherein said event management module selectively inserts routing data in each received event record based on said event record routing instruction.

46. The system of claim 41 further comprising an additional queue for said event record destination, wherein said event management module selectively inserts received event records in said additional queue based on said comparison.
